(19) United States
(12) Patent Application Publication
(10) Pub. No.: US 2006/0248081 A1
(43) Pub. Date: Nov. 2, 2006

(54) Color selection method and system

(76) Inventor: Francis Lamy, Wollerau (CH)

Correspondence Address: McCARTER & ENGLISH, LLP;Attn.: Angelica Brooks, CityPlace I, 185 Asylum Street, Hartford, CT, 06103, US

(21) Appl. No.: 11/405,062

(22) Filed: Apr. 17, 2006

(30) Foreign Application Priority Data
Apr. 27, 2005 (EP) 05 009 226.1

(51) Int. Cl. G06F 7/00

(52) U.S. Cl. 707/7

(57) ABSTRACT

A method and a system are disclosed that make it possible to select and present colors based on a semantic search thus making the color selection process more human-compatible. A word-based search mechanism makes it easier to translate a designer's inspiration to color selection. The colors selected by using the semantic color search engine have numeric color information associated with them. This enables use of the results by design software and color software used in production processes.

### BACKGROUND OF THE INVENTION

1. Field of the Invention

The invention relates to a color selection method and a corresponding system.

2. Description of the Related Art

The invention generally pertains to the field of graphic arts. More specifically, it relates to the color selection process used during graphic design or product design.

The traditional process of color selection, as it is most commonly used by creative professionals, is based on navigating through a large array of color choices to find a color that matches the designers creative concept. Physical color palettes (e.g. Pantone, RAL, NCS), available as fan-decks or color books show an assortment of color chips and are commonly used by designers. Digital equivalents for some of these palettes are also available through design or color software. In this case, colors are selected by color name or color number from a pick list. Mechanisms based on named color lists can only establish a one-to-one relationship between colors and words.

Digital color pickers (not based on color books) are commonly used in graphics and design software (Adobe Photoshop, Microsoft Office) to select and specify color. Here the color choice is made from visual presentation or based on user-defined color values.

### SUMMARY OF THE INVENTION

A primary object of the present invention is to facilitate the use of digital color tools by making the color selection process more human-compatible. Another object of the invention is to provide a method and a system which makes it possible to identify and present color selections based on a semantic input, preferably via a semantic software interface. More specifically, another object of the invention is to provide a word-based search mechanism which makes it easier to translate a designer's inspiration to color selection. Yet another object of the invention is to provide a color identification system where the colors selected by using a color search engine have numeric color information associated with them so that the selected colors can be used by design software and color software used in production processes.

According to the present invention, in particular the aforesaid main and secondary objects are met by the color selection method comprising the following steps:

a) establishing a color database (30) for a number of individual colors, wherein each color is attributed a set of data and each set of data comprises at least numeric data and semantic data related to the respective color,

b) establishing a semantic lexicon database (40) containing word-word relationships describing semantic associations that are relevant to describing colors,

c) providing search terms (23) related to a desired color, said search terms comprising at least semantic data,

d) determining related search terms (24) from said semantic lexicon database, said related search terms providing alternative semantic associations to the desired color,

e) searching the color database for resulting colors (33) with attributed data sets matching said search terms and/or said related search terms and retrieving these resulting colors, and

f) producing a visual presentation of the resulting colors.

Another aspect of the invention concerns a system comprising:

a) a color database (30) for a number of individual colors, wherein each color is attributed a set of data and each set of data comprises at least numeric data and semantic data related to the respective color,

b) a semantic lexicon database (40) containing word-word relationships describing semantic associations that are relevant to describing colors,

c) an input interface (10) for entering search terms related to a desired color, said search terms comprising at least semantic data (1),

d) a semantic analysis unit (21) for retrieving related search terms from said semantic lexicon database (40), said related search terms providing alternative semantic associations to the desired color,

e) a search engine (20-50) for searching the color database (30) and retrieving resulting colors (33) the attributed data sets of which match with said search terms and/or said related search terms, and

f) a display unit (60) for visually presenting the resulting colors (33) retrieved by the search engine.

Most generally, the inventive method and system use colorimetric calculations, database querying, a semantic lexicon and color software tools to create the system. More details and advantages of the inventive method and system will become evident from the following detailed description of a preferred embodiment of the invention. The only figure is a schematic flow chart of the most important steps and functional units of the inventive method and system.

### BRIEF DESCRIPTION OF THE DRAWING

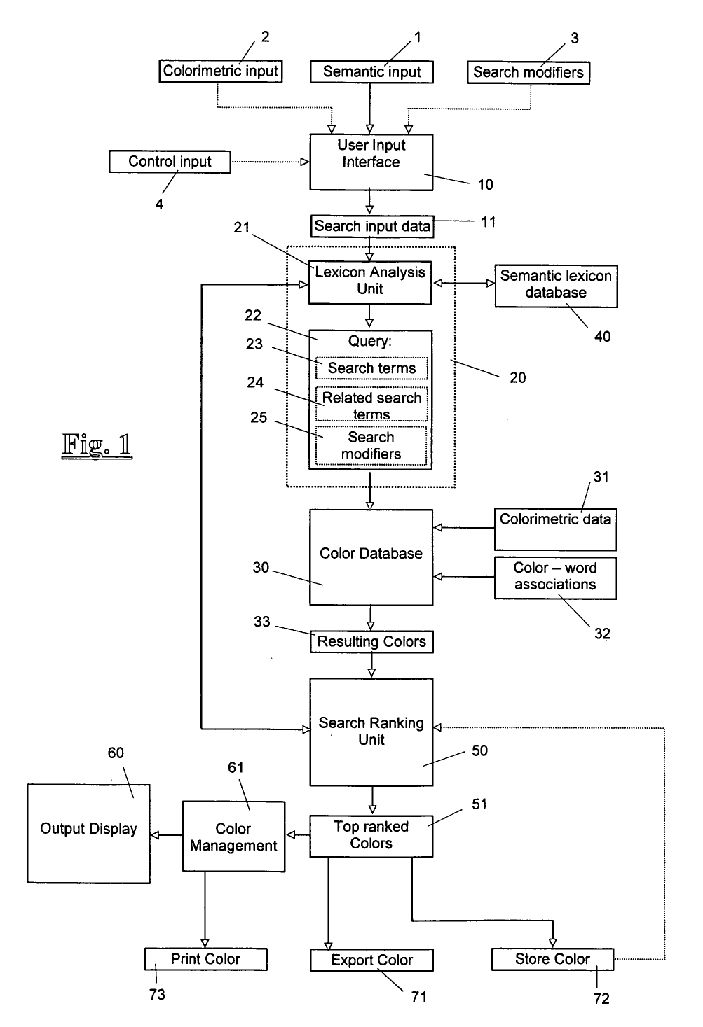

As illustrated in FIG. 1 the system basically comprises a user input interface 10, a query engine 20, a color database 30, a semantic lexicon database 40, a ranking unit 50 and a color display unit 60. The query engine 20, the color database 30, the semantic lexicon database 40 and the ranking unit 50 together can be referred to as a search engine.

### DETAILED DESCRIPTION OF THE PREFERRED EMBODIMENT

The system receives semantic input data 1 and/or colorimetric input data 2 and, if desired, search modifying input data 3 from a user. The user input interface 10 converts these input data 1 and/or 2 and 3 into corresponding digital search input data 11. E.g. search terms could be keyed in or a voice interface via connectivity with speech-to-text engines could be used. The user input interface 10 provides for these input options in conventional manner. The system also receives control input data 4 for interactive control of functionalities such as selection of colors to be presented etc.

The color database 30 contains, among others, numeric calorimetric data 31 and color-word association data 32. The semantic lexicon database 40 contains word-word relationships describing semantic associations, typically words that are relevant to describing colors.

The query engine 20 comprises a lexicon analysis unit 21 which receives input semantic search terms and retrieves related semantic search terms 24 from the semantic lexicon database 40. The query engine 20 also builds a query 22 from the input search terms 23, the related search terms 24 and the search modifiers 25 (if any). The query engine further queries the color database 30 and retrieves resulting color data 33 from the color database 30 on the basis of the query 22.

The ranking unit 50 reduces the query result data 33 to a number of top ranked color data 51 according to predefined ranking rules thereby co-operating with the semantic analysis unit 21 and the semantic lexicon database 40.

The colors defined by the top ranked color data 51 are visually (graphically) presented by the color display unit 60. A color management unit 61 may be provided for colorimetrically correct presentation of the colors. Selection of colors to be presented can be controlled by control input data 4. In addition, output means 71-73 are provided to allow for exporting, storing and printing of the top ranked colors 51. Stored colors can be used as input to the search ranking unit 50 to define user preferences.

The input interface 10, query engine 20, color database 30, semantic lexicon database 40, ranking unit 50, color display unit 60, color management unit 61 and output means 71-73 are typically implemented by a digital computer and its usual periphery in combination with suitably programmed software.

To find colors, a user enters words (semantic input data 1) as search terms. The search engine 20-50 returns a set of resulting colors associated with the word(s) entered. This set of colors is represented by result color data 33. Semantic search terms could be a part of commonly used color names (e.g. “olive”) or may have a more indirect association with color (e.g. “fresh”).

Additional search capability of the search engine could include syntax to search by typical colorimetric values e.g. RGB, Lab etc. (calorimetric input data 2) instead of words (semantic input data 1). So the user could enter “L=50.5 a=−20.6 b=12.5″ instead of a string of words to search for colors on a purely numerical basis. The search engine could be designed to interpret typical search query syntax such as “and”, “or”, “+”, “−” and quotes (“”) to further define the search. Special syntax to search for colors that are related to the search terms in a particular way could also be recognized by the search engine. For example to search for colors that are complementary to “blue” one could enter the search terms “c blue”. These additional input options are symbolized in FIG. 1 by search modifying input data 3.

The color database 30 contains several information fields for each color. This could include color name, calorimetric information (e.g. spectral data, CIE L*a*b*values), associated word(s), color library name, color code, date defined, date measured, measurement code, specified name, application method, seasonal association (e.g. spring, winter) etc.

In addition to semantic terms, a search could be further defined or refined by providing limiting values for any of the information fields. For example, this capability could be used to filter the search to just those colors that were produced by a certain application type or those colors that were defined in the last year or colors that were defined by a particular user. These additional input options too are symbolized in FIG. 1 by search modifying input data 3.

To build the color database 30, information could be compiled by several different methods. Available libraries of named colors along with the associated calorimetric data could be could be used in the simplest implementation. To gain the complete benefits of the invention, additional words besides the color names need to be associated with each color. The association between words and colors could be defined based on input from color and design professionals. To build this association, users could be presented with a series of colors and asked to provide words in response to the colors. These words could, for example, be possible color names for that color, names of objects that come to mind, words that describe scenes that come to mind or words that describe a feeling associated with a color. The responses of all participants in such color-word association “experiment” are recorded. During this process, the participant could additionally select from a list of words provided by previous participants for the same color. This can increase the efficiency with which the color-word association can be built.

A lexical database, a thesaurus database or any other software tool that provides associated words could also be used to offer word choices related to the words already entered or selected by the participant. An efficient method to gather data about color-word associations is a key to making semantic color search possible. The use of additional tools like a voice interface and “auto-fill” of words based on entered text could also be helpful. Demographic information about participants could also be compiled to allow further segmentation of the data in the search process.

Yet another mechanism for populating the color database 30 would be by connectivity for users of color software who create and work with electronic color palettes using available software tools. Such users could have the option of saving their color palettes to a local or networked database. The ability to “publish” the color palettes with named colors will provide another data stream that builds the color database 30.

It is important to note that there is a many-to-many association between colors and words. There could be several words associated with a color and several colors associated with a word.

The use of a color database (that contains color-word relationships) along with a semantic lexicon database (that contains word-word relationships) is a very important feature of the present invention.

The semantic lexicon database 40 is used in “experiments” to establish color-word relationships for the color database 30. The participant is prompted with the option to select additional words that are related to words already keyed in by them in response to presented colors. This process makes it possible to efficiently gather color-word relationship data to populate the color database.

The semantic lexicon database 40 is also used to expand color search results beyond exact word matches. So if e.g. “hot” is entered, the search engine will also look for colors associated with e.g. “fire” since it knows that “hot” and “fire” are related from the lexicon database 40.

Finally, the lexicon database 40 also plays a role in ranking of search results. For example, if a color was associated with “hot” by one participant in the color database and it was associated with “fire” by another, that color will get a higher rank when searched for “hot”. This is because the lexicon database validates and strengthens the relationship between these two words.

Since the number of colors and the number of words are extremely large, all of the color-word relationships cannot be easily and completely defined. This has prevented the practical implementation of a color search engine to date. If only a small table of color-word relationships is defined the search results will be unsatisfactory because relatively often 0 or only 1 hit will be found.

The skill in the inventive method is to expand the color-word relationships by using a supplementary table of word-word relationships. This table is implemented by the semantic lexicon database 40. So if one enters “hot” and that is not in the color database 30, one still gets a search result because there is a color with the related word “fire” in the database. This mechanism greatly reduces the probability of 0 hits.

In addition, the search engine can also use colorimetry to tackle the issue of color-color relationships. Since each of the colors have numeric color data associated with them (e.g. spectral data), it is possible to compute if two colors could be considered “neighboring” based on colorimetric distance between them. So if one is looking for “hot” and there is exactly one color with this word, the search engine will still offer the possibility of viewing an expanded selection of colors that are calculated to be neighbors of “hot”. It is also possible to determine if the colors are “complementary” based on color computations. The multiplication of relationships through word-word tables and color-color calculations allows for bringing in choice and offering a multiplicity of relevant hits from which the user can select. This is another important factor in creating a useful system.

For search result ranking (ranking unit 50), statistical measures can be used to determine the strength of association between a word and a color. The frequency with which a word (or similar words) are applied to a color (or similar colors) is calculated. The similarity of words is determined using lexical tools and by analyzing the word-color association collected from experiments conducted with design professionals. The selection of a certain color by the user from the search results could also be recorded and used later in calculating the strength of association between a word and a color, as indicated by the arrow connecting blocks 72 and 50 in FIG. 1.

The user could possibly assemble an entire color palette with a specified number of colors in one step by using a series of words in a single query. A method for calculating the composite rank for each color is used to build the palette of colors presented to the user as the search result.

Presentation of search results by the color display unit 60 could be in the form of a table of color chips with a RGB screen simulation of the calorimetric data associated with the color. Additional information fields for each of the color chips from the color database 30 could also be displayed. For cases where a large number of matching hits are found, colors that are within a certain calorimetric distance of each other could be grouped into a single mean color for initial display. The mean color could be expanded in a hierarchy to show its color members. These functionalities can be interactively controlled by the user by entering corresponding control input data 4.

Output of selected colors from the (ranked) search results are needed for use in design or application processes. Software tools to store the search results in a user-defined palette are provided (storing means 72). Exportation means 71 to export color data to commonly used color and graphics software are also provided. There could also be provided an option of viewing a history of stored search results. Printing and emailing of a HTML page with colors in different layouts from the browser is possible (printing means 73). The color management unit 61 provides for colorimetrically correct visual presentation and printing of the colors selected.

Collaborative color palette development is common in large organizations. Software for managing the workflow and finalizing the palette definition is a possible add-on for the inventive search engine. Browser-based methods will make it possible to easily review and refine a color palette interactively and collaboratively.

The invention is useful in the color selection process during graphic design or product design. The inventive method and system make it possible to select colors on the basis of a semantic search, i.e. a search based on words or numbers defined by the user, and to present ranked search results to the user, typically a creative professional. The use of digital color tools is facilitated by making the color selection process more human-compatible. The word-based search mechanism uses colorimetric calculations, database querying, a semantic lexicon and color software tools and thereby makes it easier to translate a designer's inspiration to color selection. The colors selected by using the color search engine have numeric color information associated with them. This enables use of the results by design software and color software used in production processes.

1. A method of selecting and presenting a color choice made by a user comprising the steps of:
a) establishing a color database (30) for a number of individual colors, wherein each color is attributed a set of data and each set of data comprises at least numeric data and semantic data related to the respective color,
b) establishing a semantic lexicon database (40) containing word-word relationships describing semantic associations that are relevant to describing colors,
c) providing search terms (23) related to a desired color, said search terms comprising at least semantic data,
d) determining related search terms (24) from said semantic lexicon database, said related search terms providing alternative semantic associations to the desired color,
e) searching the color database for resulting colors (33) with attributed data sets matching said search terms and/or said related search terms and retrieving these resulting colors, and
f) producing a visual presentation of the resulting colors.

2. The method according to claim 1 wherein the search terms comprise colorimetric numerical data and wherein the color database is searched for resulting colors with attributed data sets matching said colorimetric numerical data.

3. The method according to claim 1, wherein there are provided search modifying data defining filter criteria and/or logical expressions of the search terms and wherein the color database is searched for resulting colors with attributed data sets matching said filter criteria and/or said logical expressions of search terms and/or logical expressions of related search terms.

4. The method according to claim 1, wherein also colorimetrically neighboring colors are retrieved and visually presented, said colorimetrically neighboring colors being within a predefined colorimetric distance from said colors with attributed data sets matching said search terms and/or said related search terms.

5. The method according to claim 1, wherein the resulting colors are ranked according to predefined ranking criteria and only a limited number of highest ranked colors (51) are visually presented.

6. The method according to claim 5 wherein ranking is performed using said semantic lexicon database (40).

7. The method according to claim 1, wherein a series of semantic input data is provided as search terms and wherein on the basis of said series of semantic input data an entire color palette with a specified number of colors is retrieved from the color database and then visually presented.

8. A system for selecting and presenting a color choice made by a user comprising
a) a color database (30) for a number of individual colors, wherein each color is attributed a set of data and each set of data comprises at least numeric data and semantic data related to the respective color,
b) a semantic lexicon database (40) containing word-word relationships describing semantic associations that are relevant to describing colors,
c) an input interface (10) for entering search terms related to a desired color, said search terms comprising at least semantic data (1),
d) a semantic analysis unit (21) for retrieving related search terms from said semantic lexicon database (40), said related search terms providing alternative semantic associations to the desired color,
e) a search engine (20-50) for searching the color database (30) and retrieving resulting colors (33) the attributed data sets of which match with said search terms and/or said related search terms, and
f) a display unit (60) for visually presenting the resulting colors (33) retrieved by the search engine.

9. The system according to claim 8 wherein the input interface (10) accepts search modifying data defining filter criteria and/or logical expressions of the search terms and related search terms and wherein the search engine (20-50) is able to search the color database for resulting colors with attributed data sets matching said filter criteria and/or said logical expressions of search terms and related search terms.

10. The system according to claim 8, further comprising a ranking unit (50) for ranking the resulting colors (33) according to predefined ranking rules and producing a reduced set of resulting colors (51) consisting of a limited number of highest ranked resulting colors.

11. The system according to claim 10 wherein the ranking unit (50) co-operates with the lexicon analysis unit (21).

12. The system according to claim 8, further comprising exporting means (71) for exporting data related to resulting colors (33,51).

13. The system according to claim 8, further comprising storing means (72) for storing data related to resulting colors (33,51).

14. The system according to claim 8, further comprising printing means (73) for printing data related to resulting colors (33,51).

15. The system according to claim 8, further comprising a color management unit (61) for colorimetrically correct presentation and/or printing of resulting colors (33,51).
